(19) United States
(12) Patent Application Publication
(10) Pub. No.: US 2025/0231340 A1
(43) Pub. Date: Jul. 17, 2025

(54) SEMICONDUCTOR STRUCTURE, SEMICONDUCTOR DEVICE AND MANUFACTURING METHOD THEREOF

(71) Applicant: Taiwan Semiconductor Manufacturing Company, Ltd., Hsinchu (TW)

(72) Inventors: Wei-Li Lo, Hsinchu County (TW); Huan-Chieh Chen, Taichung (TW); Yao-Wen Chang, Taipei (TW)

(73) Assignee: Taiwan Semiconductor Manufacturing Company, Ltd., Hsinchu (TW)

(21) Appl. No.: 18/415,592

(22) Filed: Jan. 17, 2024

(51) Int. Cl. G02B 6/122; G02B 6/12; G02B 6/136

(52) U.S. Cl. CPC G02B 6/122; G02B 6/136; G02B 2006/12142

(57) ABSTRACT

A semiconductor structure is provided. The semiconductor structure includes a semiconductor substrate, a dielectric layer, an etching stop layer, a silicide layer, and a contact metal. The semiconductor substrate has a groove. The dielectric layer and the etching stop layer are disposed in the groove. The silicide layer is located within the semiconductor substrate. The dielectric layer has a via in the groove. The etching stop layer has a through hole under the via of the dielectric layer. The silicide layer is aligned with an inner sidewall of the through hole of the etching stop layer. The contact metal is disposed in the via.

### BACKGROUND

Photonic Integrated Circuits (PICs) are advanced systems that utilize light as the carrier of information. PICs encompass various photonic devices and optical waveguides, serving diverse applications such as high-speed optical communication and medical diagnostics. In some PICS, waveguides are designed as rib or channel configurations. Silicon waveguides, with their sub-micron dimensions, effectively confine infrared light, commonly used in data and telecommunications. These waveguides feature sections with p-type and n-type doping, forming p-n or p-i-n junctions, which act as phase-shifting components. By applying an electric field to these junctions, depletion and accumulation/injection regions are created. The optical refractive index of these regions varies with carrier concentration, resulting in a phase shift of light passing through the waveguide. This phase shifter is used to modulate light transmission through constructive and destructive interference of phase-shifted light.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flow chart of a manufacturing method of a semiconductor structure in accordance with an embodiment of the present disclosure.

FIG. 2A to FIG. 2I are cross-sectional views illustrating various stages of a manufacturing method of a semiconductor structure in accordance with an embodiment of the present disclosure.

FIG. 3 is a cross-sectional view illustrating a semiconductor structure in accordance with an embodiment of the present disclosure.

FIG. 4 is a cross-sectional view illustrating a semiconductor structure in accordance with an embodiment of the present disclosure.

FIG. 5A is a perspective view illustrating a semiconductor device in accordance with an embodiment of the disclosure.

FIG. 5B is a cross-sectional view taken along line A-A′ of FIG. 5A.

FIG. 6 is a cross-sectional view illustrating a semiconductor device in accordance with an embodiment of the disclosure.

FIG. 7 is a perspective view illustrating a semiconductor device in accordance with an embodiment of the disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the structure in use or operation in addition to the orientation depicted in the figures. The apparatus may be otherwise oriented (rotated 90 degrees or at other orientations) and the spatially relative descriptors used herein may likewise be interpreted accordingly.

In certain photonic integrated circuits, waveguides are structured as ribs or grooves. Silicon waveguides, characterized by sub-micron dimensions, can effectively confine infrared light, typically with wavelengths greater than about 700 nm. This confinement is achieved due to a significant optical refractive index contrast between the core material (e.g., silicon with a refractive index around n=3.47) and the cladding layers (e.g., silicon dioxide with a refractive index around n=1.45). Silicon waveguides find applications in data communications (with wavelength about 1310 nm) and telecommunications (with wavelength about 1550 nm).

Semiconductor waveguides with p-type doped regions and n-type doped regions forming either a p-n or p-i-n junction can function as phase shifters. Applying an electric field to the p-n or p-i-n junction leads to the formation of depletion and accumulation/injection regions. The optical refractive index of the phase shifting portion of the semiconductor waveguide varies depending on carrier concentration, either depletion or accumulation, inducing a phase shift to the light propagating in the waveguide through the phase shifting portion. This phase shifter can be employed to modulate light transmission via constructive and destructive interference of phase-shifted light. In addition to modulating light transmission through variations in carrier concentration, in other semiconductor waveguides, it is also possible to alter the characteristics of the light propagation portion within the semiconductor waveguides using the heat generated by carriers/current. This achieves an alternative method of modulating light transmission. In examples where heat is used to vary the characteristics of semiconductor waveguides, both sides of the light propagation portion can have the same doping type, such as both being n-type doped regions or both being p-type doped regions.

The light propagation region of the waveguide, as described above, can take the form of a rib structure formed on an insulating substrate, extending in the nominal direction of guided light. This rib structure is positioned between a pair of grooves formed (e.g., by etching process) within a semiconductor substrate (e.g., silicon) above an insulating layer. These grooves are separated from each other in the direction perpendicular to their length, i.e., perpendicular to the nominal direction of light propagation within the waveguide. The rib structure has a specific height or thickness from the insulating layer, which, in some cases, is a buried insulator, often referred to as a buried oxide layer (BOX) layer.

Such rib structures require the creation of deep grooves. To fill these grooves with insulating material without the generation of cracks, the flowable insulating materials may be used. For instance, flowable insulating materials formed by methods such as Flowable Chemical Vapor Deposition (FCVD) can be utilized. Examples of such materials include phospho-silicate glass (PSG), boro-silicate glass (BSG), boron-doped phospho-silicate glass (BPSG), undoped silicate glass (USG), or the like. However, these flowable insulating materials require subsequent curing through a heat treatment process. Such a heat treatment process can potentially lead to the decomposition of silicides disposed on the semiconductor substrate, which in turn affects the contact resistance between metal contacts and the semiconductor substrate. In this disclosure, in-situ deposition of silicide is performed after curing the flowable insulating material. This approach effectively mitigates the issue of silicide decomposition, thereby improving the ohmic contact between the metal contacts and the semiconductor substrate.

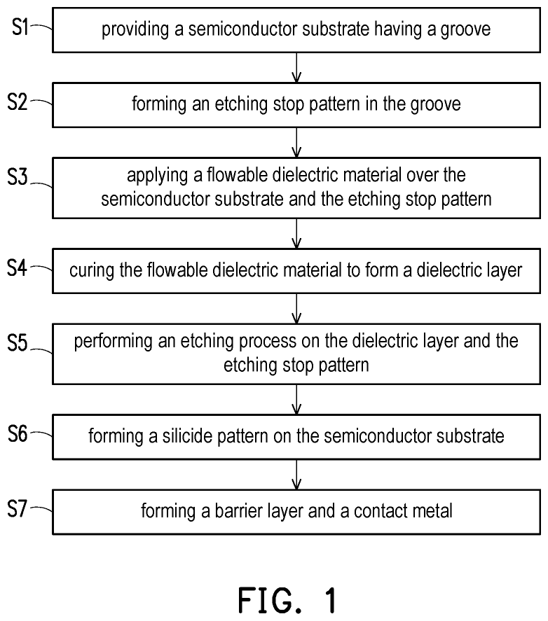

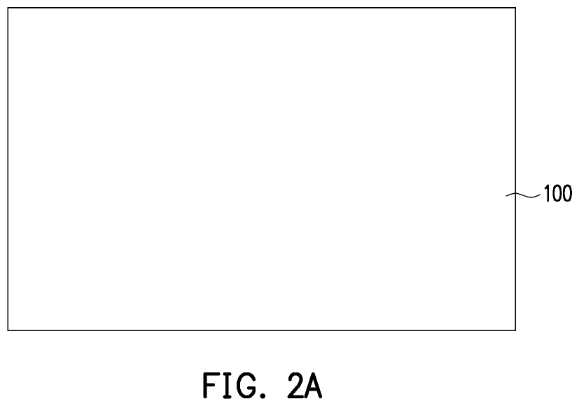

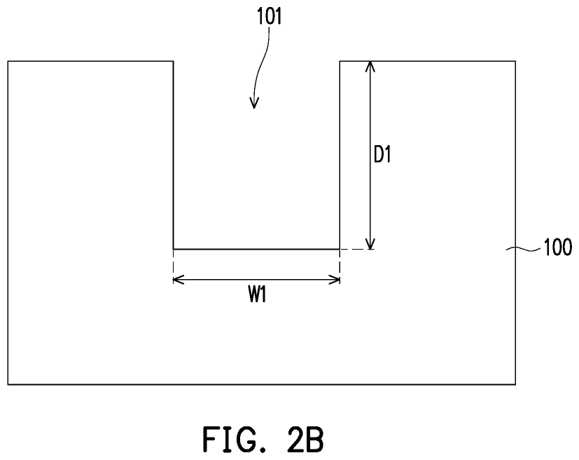

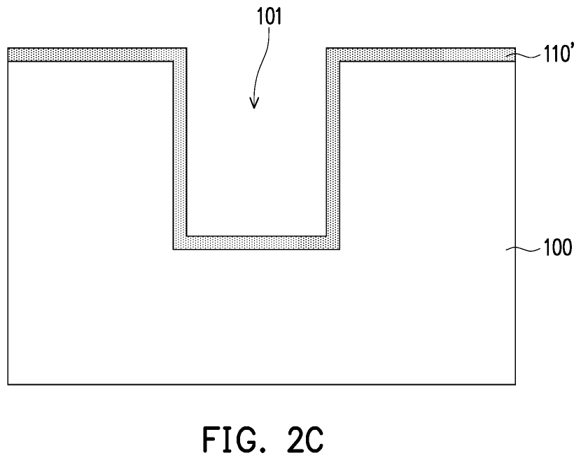

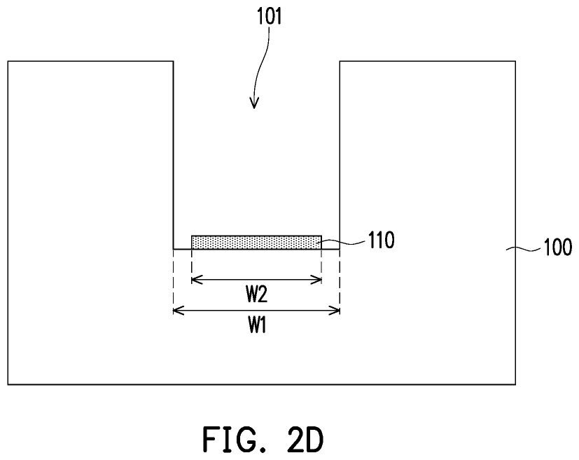

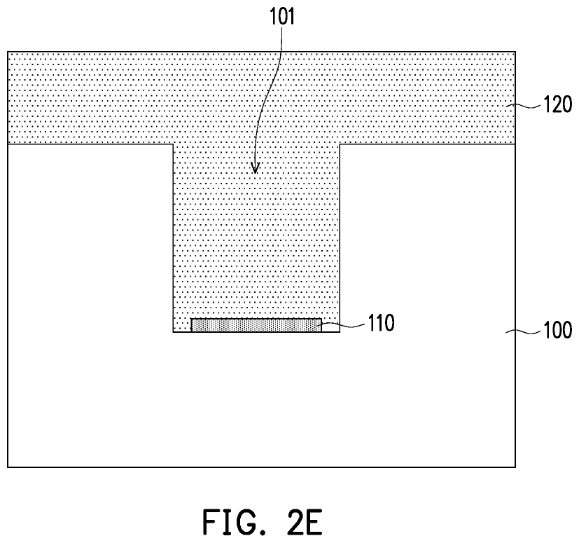

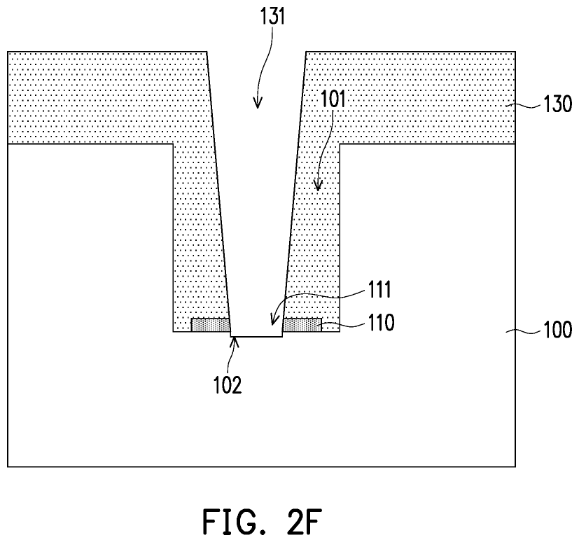

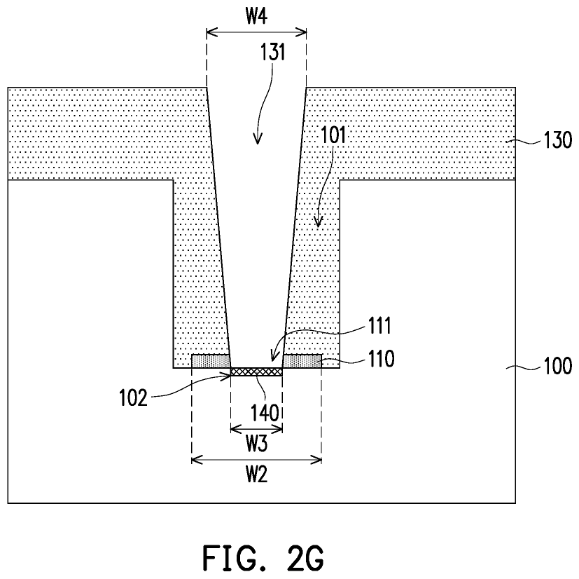

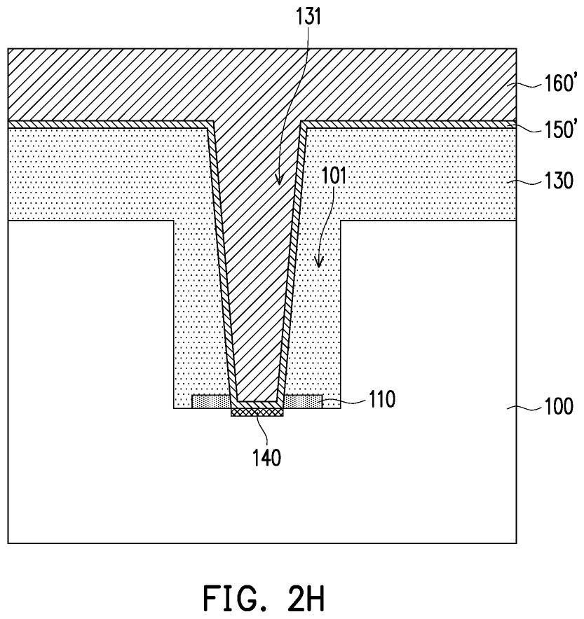

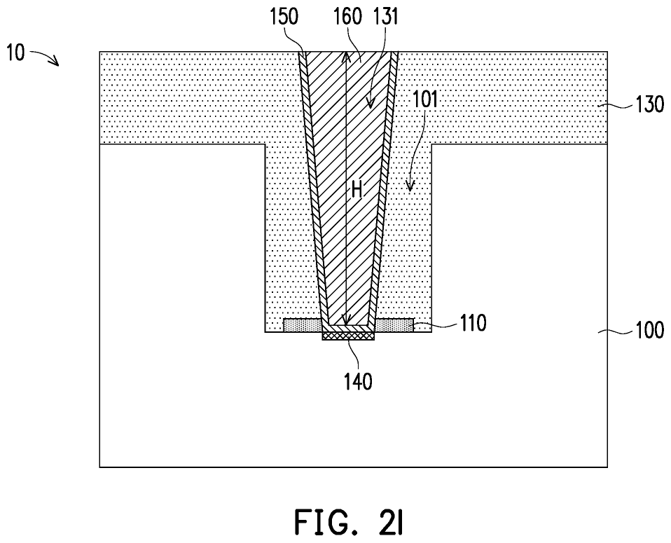

FIG. 1 is a flow chart of a manufacturing method of a semiconductor structure 10 in accordance with an embodiment of the present disclosure. FIG. 2A to FIG. 2I are cross-sectional views illustrating various stages of a manufacturing method of the semiconductor structure 10 in accordance with an embodiment of the present disclosure. The semiconductor structure 10 can be combined with various types of semiconductor devices as needed, including but not limited to a photonics modulator device, a transistor, or other active or passive components.

Referring to the steps S1 in FIG. 1 and the corresponding FIGS. 2A and 2B, a semiconductor substrate 100 is provided. In some embodiments, the semiconductor substrate 100 may include an elemental (i.e., having a single element) semiconductor, such as silicon (Si), germanium (Ge), or other suitable materials; a compound semiconductor, such as silicon carbide, gallium arsenic, gallium phosphide, indium phosphide, indium arsenide, indium antimonide, other suitable materials, or combinations thereof; an alloy semiconductor, such as SiGe, GaAsP, AlInAs, AlGaAs, GaInAs, GaInP, GaInAsP, other suitable materials, or combinations thereof. The semiconductor substrate 100 may be a single-layer material having a uniform composition. Alternatively, the semiconductor substrate 100 may include multiple material layers having similar or different compositions suitable for manufacturing the semiconductor structure 10.

In some embodiments, the depth D1 of the groove 101 is in a range from about 200 nm to about 3000 nm. For example, the depth D1 may range from 500 nm to 3000 nm, 1000 nm to 3000 nm, 1500 nm to 3000 nm, 2000 nm to 3000 nm, or 2500 nm to 3000 nm. In some embodiments, the width W1 of the groove 101 is in a range from about 500 nm to about 20000 nm. For example, the width W1 may range from 500 nm to 10000 nm, 500 nm to 5000 nm, 500 nm to 3000 nm, 500 nm to 2000 nm, or 500 nm to 1000 nm.

An etching process is performed on the semiconductor substrate 100 to form one or more groove 101. The aforementioned etching process can be wet etching, dry etching, or any other suitable process. In the illustration, the sidewalls of the groove 101 are perpendicular to its bottom surface, but this disclosure is not limited thereto. In other embodiments, the groove 101 may have inclined sidewalls, curved sidewalls, or other shapes of sidewalls.

In some embodiments, the semiconductor substrate 100 may be doped with p-type and/or n-type impurities. The doping process on the semiconductor substrate 100 may be performed before or after the etching process. The doping process may be achieved using methods such as ion implantation, thermal diffusion, or other suitable techniques. In some embodiments, there is p-type doped region and/or n-type doped region (not shown) under the bottom surface of the groove 101.

Referring to the steps S2 in FIG. 1 and the corresponding FIGS. 2C and 2D, an etching stop pattern 110 is formed in the groove 101. In some embodiments, a blanket etching stop material layer 110′ is formed over the semiconductor substrate 100. The etching stop material layer 110′ conformally covers the upper surface of the semiconductor substrate 100, the sidewalls of the groove 101, and the bottom surface of the groove 101. The etching stop material layer 110′ is made of a material different from that of the semiconductor substrate 100. For example, the etching stop material layer 110′ may consist of nitride, such as SiOCN, SIN, SiCN, or other suitable material. In some embodiments, the etching stop material layer 110′ is formed using processes like Atomic Layer Deposition (ALD), Chemical Vapor Deposition (CVD), Physical Vapor Deposition (PVD), or other appropriate methods, or combinations thereof.

In some embodiments, the etching stop material layer 110′ is patterned to form an etching stop pattern including one or more etching stop layer 110. The etching stop layer 110 is disposed in the groove 101 and does not extend to the sidewalls of the groove 101 and the top surface of the semiconductor substrate 100. When the semiconductor structure 10 (referring to FIG. 2I) is used for a photonics modulator device, reducing the coverage area of the etching stop layer 110 on the semiconductor substrate 100 can help prevent optical losses. However, this disclosure is not limited thereto. In other embodiments, the etching stop material layer 110′ may not be patterned. In such case, the etching stop layer covers not only the bottom surface of the groove 101 but also the sidewalls of the groove 101 and the top surface of the semiconductor substrate 100.

In some embodiments, the etching stop layer 110 is formed by a patterning process, and a width W2 of the etching stop layer 110 is smaller than a width W1 of the bottom surface of the groove 101. In some embodiments, the sidewalls of the etching stop layer 110 is separated from the sidewalls of the groove 101.

Referring to the steps S3 in FIG. 1 and the corresponding FIG. 2E, a flowable dielectric material 120 is applied over the semiconductor substrate 100 and the etching stop layer 110. For instance, the flowable insulating material 120 is formed by a flowable chemical vapor deposition (FCVD) or other suitable process. In some embodiments, the flowable insulating material 120 includes phospho-silicate glass (PSG), boro-silicate glass (BSG), boron-doped phospho-silicate glass (BPSG), undoped silicate glass (USG), or the like. In the example where the flowable dielectric material 120 is BPSG, the weight ratio of boron to phosphorus (B/P) is approximately 1 wt % to 20 wt %.

Then, referring to the steps S4 and S5 in FIG. 1 and the corresponding FIGS. 2E and 2F, the flowable insulating material 120 is curing by a thermal process. For example, curing the flowable insulating material 120 can be performed at the temperature exceeding 300 degrees Celsius, such as in the range of 300 degrees Celsius to 1200 degrees Celsius, 400 degrees Celsius to 900 degrees Celsius, or 500 degrees Celsius to 600 degrees Celsius.

The dielectric layer 130 is formed by curing the flowable insulating material 120. The dielectric layer 130 is disposed in the groove 101 and over the top surface of the semiconductor substrate 100. An etching process is performed on the dielectric layer 130 and the etching stop pattern (i.e. the etching stop layer 110) to expose the semiconductor substrate 100 under the etching stop pattern (i.e. the etching stop layer 110).

One or more via 131 in the dielectric layer 130 and one or more through hole 111 in the etching stop pattern is formed by the etching process. Optionally, during the etching process, over-etching may occur, leading to the formation of a notch 102 in the semiconductor substrate 100 beneath the through hole 111. The notch 102 is align with the through hole 111 and the via 131.

Referring to the steps S6 in FIG. 1 and the corresponding FIG. 2G, a silicide pattern including one or more silicide layer 140. is formed on the semiconductor substrate 100 exposed by the etching stop pattern (i.e. the etching stop layer 110). Each silicide layer 140 is formed in a corresponding one notch 102. The width W3 of the silicide layer 140 is smaller than a width W2 of the etching stop layer 110. The width W3 of the silicide layer 140 is smaller than or equal to a width W4 of the via 131. In some embodiments, the width W3 of the silicide layer 140 is in a range from about 100 nm to about 2000 nm. For example, the width W3 may range from 500 nm to 1500 nm, or 800 nm to 1200 nm.

In certain embodiments, the process for forming the silicide pattern involves introducing a metal-containing precursor containing metallic elements (such as W, Co, Ti, Ni, or the like) into the via 131 to in-situ generate the silicide layer 140 on the exposed semiconductor substrate 100. In some instances, the silicide layer 140 may consist of materials like WSix, CoSix, TiSix, NiSix, or the like. In some embodiments, x is in a range from 1 to 2. Since the metal-containing precursor reacts with the semiconductor substrate 100 but does not react with the dielectric layer 130, the silicide layer 140 will not form on the dielectric layer 130. The silicide layer 140 is formed in the notch 102 beneath the through hole 111. In some embodiments, the thickness of the silicide layer 140 is in a range from 10 angstroms to 100 angstroms.

In this embodiment, because the silicide layer 140 is formed after the thermal process used for curing the dielectric layer 130, the aforementioned thermal process cannot cause damage to the silicide layer 140.

Referring to the steps S7 in FIG. 1 and the corresponding FIG. 2H and FIG. 2I, a barrier material layer 150′ is formed over the dielectric layer 130 and in the via 131. The barrier material layer 150′ is conformally formed and covers the via 131, the through hole 111, the silicide layer 140 and the top surface of the dielectric layer 130. The barrier material layer 150′ may be used to enhance the adhesion between the subsequently deposited metal layer 160′ and the dielectric layer 130. In other words, the barrier material layer 150′ may act as a glue layer. In some embodiments, the barrier material layer 150′ may prevent the metal element of the metal layer 160′ from diffusing into the dielectric layer 130. For example, the material of the barrier material layer 150′ includes metal nitrides, such as TaN, TiN, TaTiN, or other suitable materials, or the combination thereof. In some embodiments, the barrier material layer 150′ may be formed using processes like Chemical Vapor Deposition (CVD), Atomic Layer Deposition (ALD), Physical Vapor Deposition (PVD), and/or other appropriate methods. The barrier material layer 150′ may be a single layer or a multi-layer structure.

The metal layer 160′ is formed over the barrier material layer 150′ and in the via 131. The metal layer 160′ may be made of ruthenium, copper, tungsten, aluminum, molybdenum, titanium, tantalum, palladium, platinum, cobalt, nickel, other applicable low-resistance materials, or a combination thereof. The metal layer 160′ may be formed by a physical vapor deposition process (PVD, e.g., evaporation or sputtering), an atomic layer deposition process (ALD), an electroplating process, other applicable processes, or a combination thereof.

A planarization process is performed to remove the excess portion of the barrier material layer 150′ beyond the via 131 and the excess portion of the metal layer 160′ beyond the via 131. The remain portion of the barrier material layer comprises a barrier pattern including one or more barrier layer 150. The barrier layer 150 lines the via 131, the through hole 111 and the silicide layer 140. The remain portion of the metal layer comprises one or more contact metal 160. The contact metal 160 fills in the via 131. The barrier layer 150 is disposed between the dielectric layer 130 and the contact metal 160 and between the silicide layer 140 and the contact metal 160. In some embodiments, the thickness of the barrier layer 150 is in a range from 30 angstroms to 500 angstroms. In some embodiments, the height H of the contact metal 160 is in a range from about 500 nm to about 4000 nm. For example, the height H may range from 1000 nm to 3500 nm, 1500 nm to 3000 nm, or 2000 nm to 2500 nm.

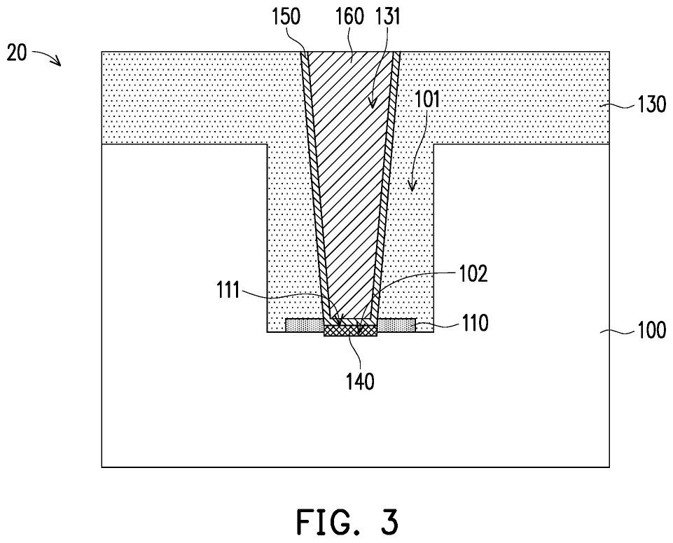

FIG. 3 is a cross-sectional view illustrating a semiconductor structure 20 in accordance with an embodiment of the present disclosure. It should be noted herein that, in embodiments provided in FIG. 3, element numerals and partial content of the embodiments provided in FIG. 2A to FIG. 2I are followed, the same or similar reference numerals being used to represent the same or similar elements, and description of the same technical content being omitted. For a description of an omitted part, reference may be made to the foregoing embodiment, and the descriptions thereof are omitted herein.

The distinction between the semiconductor structure 20 in FIG. 3 and the semiconductor structure 10 in FIG. 2I lies in the fact that the top surface of the silicide layer 140 is flush with the bottom surface of the etching stop layer 110 in the semiconductor structure 10, whereas in the semiconductor structure 20, the top surface of the silicide layer 140 is higher than the bottom surface of the etching stop layer 110.

In semiconductor structure 20, the silicide layer 140 fills the notch 102 in the semiconductor substrate 100, and the silicide layer 140 makes contact with the inner sidewall of the through hole 111 of the etching stop layer 110.

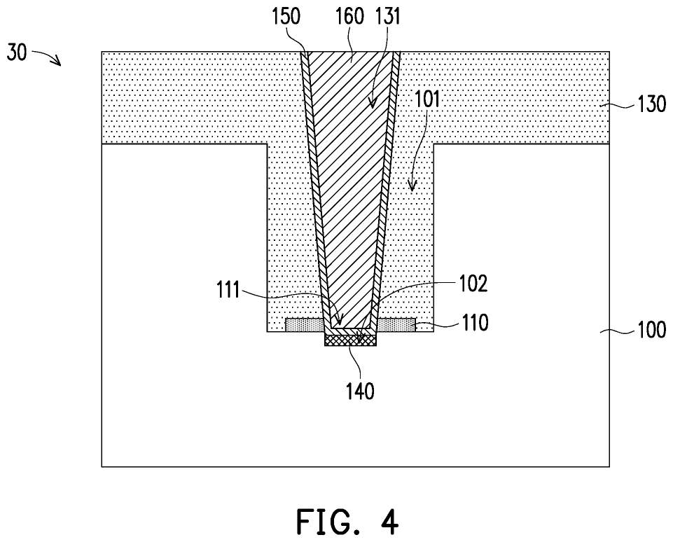

FIG. 4 is a cross-sectional view illustrating a semiconductor structure 30 in accordance with an embodiment of the present disclosure. It should be noted herein that, in embodiments provided in FIG. 4, element numerals and partial content of the embodiments provided in FIG. 2A to FIG. 2I are followed, the same or similar reference numerals being used to represent the same or similar elements, and description of the same technical content being omitted. For a description of an omitted part, reference may be made to the foregoing embodiment, and the descriptions thereof are omitted herein.

The distinction between the semiconductor structure 30 in FIG. 4 and the semiconductor structure 10 in FIG. 2I lies in the fact that the top surface of the silicide layer 140 is flush with the bottom surface of the etching stop layer 110 in the semiconductor structure 10, whereas in the semiconductor structure 30, the top surface of the silicide layer 140 is lower than the bottom surface of the etching stop layer 110. In the semiconductor structure 30, the bottom surface of the etching stop layer 110 is separated from the silicide layer 140.

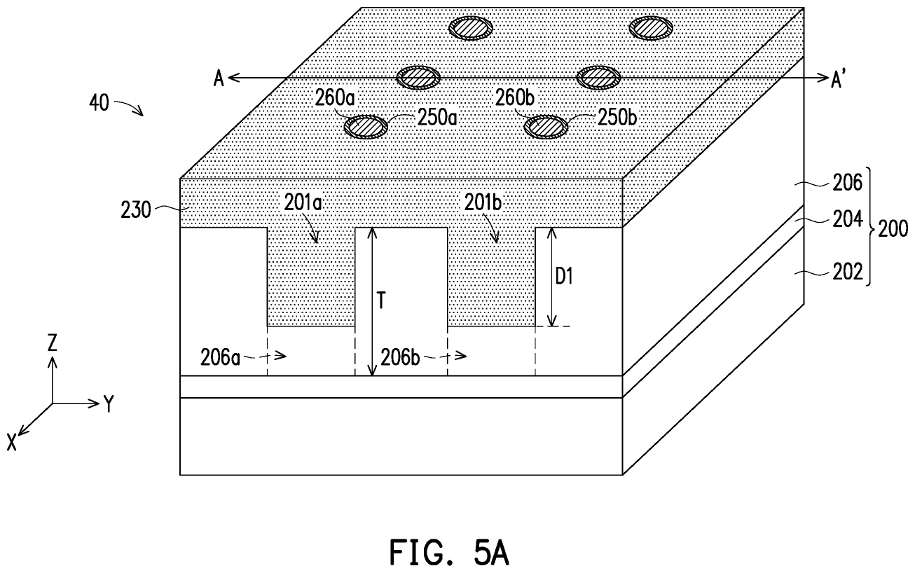

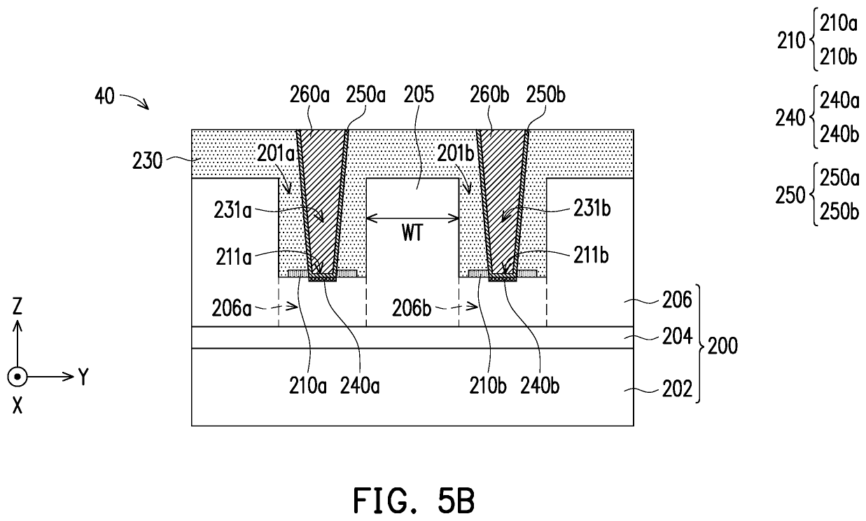

FIG. 5A is a perspective view illustrating a semiconductor device 40 in accordance with an embodiment of the disclosure. FIG. 5B is a cross-sectional view taken along line A-A′of FIG. 5A. It should be noted herein that, in embodiments provided in FIG. 5A and FIG. 5B, element numerals and partial content of the embodiments provided in FIG. 2A to FIG. 2I are followed, the same or similar reference numerals being used to represent the same or similar elements, and description of the same technical content being omitted. For a description of an omitted part, reference may be made to the foregoing embodiment, and the descriptions thereof are omitted herein.

Referring to FIG. 5A and FIG. 5B, the semiconductor device 40 is a photonics modulator device including a waveguide structure 200, an etching stop pattern 210, a dielectric layer 230, a silicide pattern 240, a barrier pattern 250, a first contact metal 260a and a second contact metal 260b.

The waveguide structure 200 includes a base layer 202, an insulation layer 204 disposed on the top of the base layer 202, and a semiconductor substrate 206. The semiconductor substrate 206 has a first groove 201a and a second groove 201b. The formation method for the first groove 201a and the second groove 201b can be referred to FIG. 2A, FIG. 2B, and the related descriptions. The semiconductor substrate 206 has a protrusion 205 between the first groove 201a and the second groove 201b. According to one aspect of the disclosure, the semiconductor substrate 206 guided light is substantially confined in the protrusion 205. In this example, the protrusion 205 extends primarily in a longitudinal direction X. The semiconductor substrate 206 at the location of the protrusion 205 has a thickness T in direction Z, which is substantially perpendicular to the longitudinal direction X. In some embodiments, the thickness T is in a range from about 2000 nm to about 4000 nm. For example, the thickness T may range from 2500 nm to 4000 nm, 3000 nm to 4000 nm, or 3500 nm to 4000 nm. The thickness T is larger than the depth D1 of the first groove 201a and the second groove 201b. The protrusion 205 has a nominal cross-sectional width WT in a direction Y substantially perpendicular to both direction X and direction Z. In some embodiments, the width WT is in a range from about 500 nm to about 4000 nm. For example, the width WT may range from 1000 nm to 4000 nm, 2000 nm to 4000 nm, or 3000 nm to 4000 nm.

In some embodiments, the semiconductor substrate 206 is doped to include a first doping region 206a and a second doping region 206b. In some embodiments, the first doping region 206a and the second doping region 206b comprise different doping types, forming either a p-n junction or a p-i-n junction. In other embodiments, the first doping region 206a and the second doping region 206b contain the same doping type, such as both being n-type doping or both being p-type doping.

The etching stop pattern 210 comprising a first etching stop layer 210a and a second etching stop layer 210b is formed in the first groove 201a and the second groove 201b. The formation method for the etching stop pattern 210 can be found in FIG. 2C, FIG. 2D, and the accompanying descriptions. The first etching stop layer 210a and the second etching stop layer 210b are respectively disposed in the first groove 201a and the second groove 201b. The first etching stop layer 210a is separated from the second etching stop layer 210b. The first etching stop layer 210a has a first through hole 211a, and the second etching stop layer 210b has a second through hole 211b.

The dielectric layer 230 is filled into the first groove 201a and the second groove 201b. The dielectric layer 230 covers the protrusion 205 of the semiconductor substrate 206. The dielectric layer 230 has a first via 231a in the first groove 201a and a second via 231b in the second groove 201b. The first through hole 211a of the first etching stop layer 210a is overlapping with the first via 231a, and the second through hole 211b of the second etching stop layer 210b is overlapping with the second via 231b. The formation method for the first through hole 211a, the second through hole 211b, the first via 231a and the second via 231b can be found in FIG. 2E, 2F, and the accompanying descriptions. In some embodiments, the dielectric layer 230 is formed by a flowable insulating material using a flowable chemical vapor deposition (FCVD) or other suitable process.

The silicide pattern 240 is located in the semiconductor substrate 206. The silicide pattern 240 comprises a first silicide layer 240a under the first via 231a and a second silicide layer 240b under the second via 231b. The width of the first silicide layer 240a is smaller than or equal to the width of the first via 231a, and the width of the second silicide layer 240b is smaller than or equal to the width of the second via 231b. In some embodiments, the method for forming the silicide pattern 240 can be referenced in the previous FIG. 2G and related descriptions. In some embodiments, the width of the first silicide layer 240a is equal to the width of the first through hole 211a, and the width of the second silicide layer 240b is equal to the width of the second through hole 211b.

The first silicide layer 240a is aligned with an inner sidewall of the first through hole 211a of the first etching stop layer 210a, and the second silicide layer 240b is aligned with an inner sidewall of the second through hole 211b of the second etching stop layer 210b. The first silicide layer 240a may or may not make contact with the first etching stop layer 210a, and the second silicide layer 240b may or may not make contact with the second etching stop layer 210b. The structure of the silicide layer in contact with the inner sidewall the etching stop layer can be referred to the semiconductor structure 20 of FIG. 3. The structure of the silicide layer separated from the etching stop layer can be referred to the semiconductor structure 30 of FIG. 4.

The barrier pattern 250 comprising a first barrier layer 250a and a second barrier layer 250b. The first barrier layer 250a and the second barrier layer 250b are respectively disposed in the first via 231a and the second via 231b. The first contact metal 260a and the second contact metal 260b are respectively disposed in the first via 231a and the second via 231b. The first barrier layer 250a is located between the first contact metal 260a and the dielectric layer 230, and the second barrier layer 250b is located between the second contact metal 260b and the dielectric layer 230. The method for forming the barrier pattern 250, the first contact metal 260a, and the second contact metal 260b can be referred to the previous FIG. 2H, FIG. 2I, and related descriptions.

The first contact metal 260a and the second contact metal 260b are electrically connected to the first doping region 206a and the second doping region 206b, respectively. By applying voltage/current to the first contact metal 260a and the second contact metal 260b, it is possible to adjust the temperature or the carrier concentration of the first doping region 206a and the second doping region 206b, thereby achieving dimming or modulation of light.

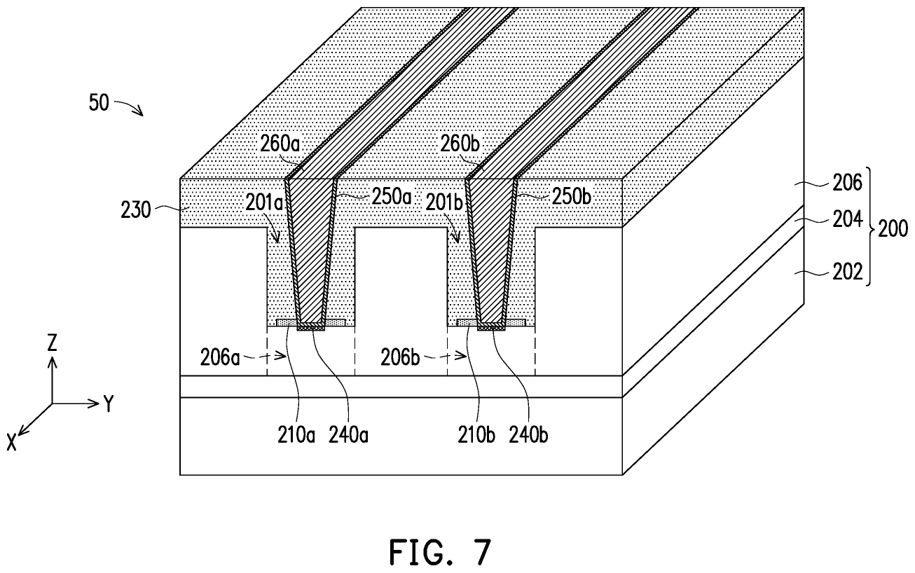

In some embodiments, along the extension direction of the first groove 201a and the second groove 201b (i.e., direction X), multiple first contact metals 260a can be formed within a single first groove 201a, and multiple second contact metals 260b can be formed within a single second groove 201b. Multiple first contact metals 260a are arranged along the direction X, and multiple second grooves 201b are also arranged along the direction X. However, this disclosure is not limited thereto. In other embodiments, as shown in the semiconductor device 50 of FIG. 7, the first contact metal 260a and the second groove 201b can be elongated strips extending along the direction X. In this case, a single first groove 201a may contain only one first contact metal 260a, and a single second groove 201b may contain only one second contact metal 260b.

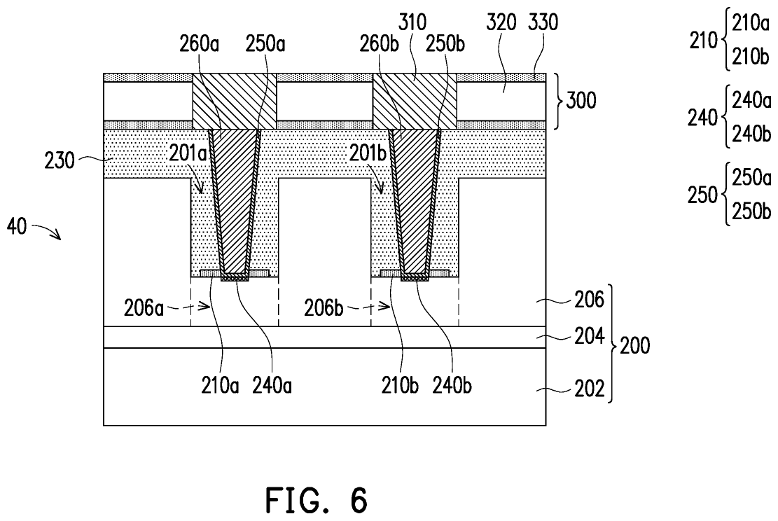

In some embodiments, an interconnect structure 300 is formed above the semiconductor device 40, as shown in FIG. 6. The interconnect structure 300 may include one or more insulating layers 320, one or more etching stop layers 330, and one or more metal interconnects 310. The metal interconnects 310 can be formed within the insulating layer 320 using a single or dual damascene process. The metal interconnects 310 are electrically connected to the first contact metal 260a and the second contact metal 260b.

In accordance of an embodiment of the present disclosure, a semiconductor structure comprises a semiconductor substrate, a dielectric layer, an etching stop layer, a silicide layer and a contact metal. The semiconductor substrate has a groove. The dielectric layer is disposed in the groove, and having a via in the groove. The etching stop layer is disposed in the groove and has a through hole under the via of the dielectric layer. The silicide layer is located within the semiconductor substrate and is aligned with an inner sidewall of the through hole of the etching stop layer. The contact metal is disposed in the via.

In accordance of another embodiment of the present disclosure, a semiconductor device comprises a semiconductor substrate, a dielectric layer, a silicide pattern, a first contact metal and a second contact metal. The semiconductor substrate has a first groove and a second groove. The dielectric layer is filled into the first groove and the second groove. The dielectric layer has a first via in the first groove and a second via in the second groove. The silicide pattern is located in the semiconductor substrate and comprises a first silicide layer under the first via and a second silicide layer under the second via. A width of the first silicide layer is smaller than or equal to a width of the first via. A width of the second silicide layer is smaller than or equal to a width of the second via. A first contact metal and a second contact metal are respectively disposed in the first via and the second via.

In accordance of another embodiment of the present disclosure, a manufacturing method of a semiconductor device comprises the following steps: providing semiconductor substrate having a first groove and a second groove; forming an etching stop pattern in the first groove and the second groove; applying a flowable dielectric material over the semiconductor substrate and the etching stop pattern; curing the flowable dielectric material by a thermal process to form a dielectric layer disposed in the first groove and the second groove; performing an etching process on the dielectric layer and the etching stop pattern to expose the semiconductor substrate under the etching stop pattern, wherein the dielectric layer has a first via in the first groove and a second via in the second groove after the etching process; forming a silicide pattern on the semiconductor substrate exposed by the etching stop pattern; and forming a first contact metal in the first via and a second contact metal in the second via.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor structure, comprising:
a semiconductor substrate having a groove;
a dielectric layer, disposed in the groove, and having a via in the groove;
an etching stop layer, disposed in the groove, wherein the etching stop layer has a through hole under the via of the dielectric layer;
a silicide layer, located within the semiconductor substrate, wherein the silicide layer is aligned with an inner sidewall of the through hole of the etching stop layer; and
a contact metal, disposed in the via.

2. The semiconductor structure of claim 1, further comprises:
a barrier layer, disposed between the dielectric layer and the contact metal and between the silicide layer and the contact metal, wherein a thickness of the barrier layer is in a range from 30 angstroms to 500 angstroms.

3. The semiconductor structure of claim 1, wherein a width of the silicide layer is smaller than a width of the etching stop layer, and a width of the etching stop layer is smaller than a width of the bottom surface of the groove.

4. The semiconductor structure of claim 1, wherein a depth of the groove is in a range from about 200 nm to about 3000 nm, a width of the groove is in a range from about 500 nm to about 20000 nm, a width of the silicide layer is in a range from 100 nm to 2000 nm, a thickness of the silicide layer is in a range from 10 angstroms to 100 angstroms, and a height of the contact metal is in a range from about 500 nm to about 4000 nm.

5. The semiconductor structure of claim 1, wherein the silicide layer comprises WSix, CoSix, TiSix, or NiSix, wherein x is in a range from 1 to 2.

6. The semiconductor structure of claim 1, wherein the semiconductor substrate has a notch under the through hole of the etching stop layer, and the silicide layer is located in the notch.

7. The semiconductor structure of claim 1, wherein a bottom surface of the etching stop layer is separated from a top surface of the silicide layer.

8. A semiconductor device, comprising:
a semiconductor substrate having a first groove and a second groove;
a dielectric layer, filled into the first groove and the second groove, wherein the dielectric layer has a first via in the first groove and a second via in the second groove;
a silicide pattern, located in the semiconductor substrate, wherein the silicide pattern comprises a first silicide layer under the first via and a second silicide layer under the second via, wherein a width of the first silicide layer is smaller than or equal to a width of the first via, and a width of the second silicide layer is smaller than or equal to a width of the second via; and
a first contact metal and a second contact metal, respectively disposed in the first via and the second via.

9. The semiconductor device of claim 8, further comprises
an etching stop pattern, comprising a first etching stop layer disposed in the first groove and a second etching stop layer disposed in the second groove, wherein the first etching stop layer is separated from the second etching stop layer, the first etching stop layer has a first through hole overlapping with the first via, and the second etching stop layer has a second through hole overlapping with the second via.

10. The semiconductor device of claim 9, wherein the first silicide layer is aligned with an inner sidewall of the first through hole.

11. The semiconductor device of claim 9, wherein the first silicide layer is in contact with an inner sidewall of the first through hole.

12. The semiconductor device of claim 9, wherein a width of the first silicide layer is equal to a width of the first through hole.

13. The semiconductor device of claim 8, wherein the semiconductor substrate has a protrusion between the first via and the second via.

14. The semiconductor device of claim 13, wherein the dielectric layer covers the protrusion of the semiconductor substrate.

15. A manufacturing method of a semiconductor device, comprising:
providing a semiconductor substrate having a first groove and a second groove;
forming an etching stop pattern in the first groove and the second groove;
applying a flowable dielectric material over the semiconductor substrate and the etching stop pattern;
curing the flowable dielectric material by a thermal process to form a dielectric layer disposed in the first groove and the second groove;
performing an etching process on the dielectric layer and the etching stop pattern to expose the semiconductor substrate under the etching stop pattern, wherein the dielectric layer has a first via in the first groove and a second via in the second groove after the etching process;
forming a silicide pattern on the semiconductor substrate exposed by the etching stop pattern; and
forming a first contact metal in the first via and a second contact metal in the second via.

16. The manufacturing method of claim 15, wherein the forming the first contact metal in the first via and the second contact metal in the second via comprises:
forming a barrier material layer over the dielectric layer and in the first via and in the second via;
forming a metal layer over the barrier material layer and in the first via and in the second via; and
performing a planarization process to remove an excess portion of the barrier material layer and an excess portion of the metal layer beyond the first via and the second via, wherein a remain portion of the barrier material layer comprises a first barrier layer lining the first via and a second barrier layer lining the second via, and wherein a remain portion of the metal layer comprises the first contact metal and the second contact metal.

17. The manufacturing method of claim 15, wherein the forming the etching stop pattern in the first groove and the second groove comprises:
forming an etching stop material layer over the semiconductor substrate; and
patterning the etching stop material layer to from the etching stop pattern comprising a first etching stop layer disposed in the first groove and a second etching stop layer disposed in the second groove, wherein the first etching stop layer is separated from the second etching stop layer.

18. The manufacturing method of claim 15, wherein the etching process forms a first through hole of the first etching stop layer and a second through hole of the second etching stop layer, and the etching process further forms a first notch of the semiconductor substrate under the first through hole and a second notch of the semiconductor substrate under the second through hole, wherein the silicide pattern is formed in the first notch and the second notch.

19. The manufacturing method of claim 15, wherein the flowable dielectric material comprises phospho-silicate glass, boro-silicate glass, boron-doped phospho-silicate glass, or undoped silicate glass.

20. The manufacturing method of claim 15, wherein the silicide pattern comprises a first silicide layer under the first via and a second silicide layer under the second via, wherein a width of the first silicide layer is smaller than or equal to a width of the first via, and a width of the second silicide layer is smaller than or equal to a width of the second via.
